(19) United States
(12) Patent Application Publication
(10) Pub. No.: US 2020/0013386 A1
(43) Pub. Date: Jan. 9, 2020

(54) METHOD AND APPARATUS FOR OUTPUTTING VOICE

(71) Applicant: Baidu Online Network Technology (Beijing) Co., Ltd., Beijing (CN)

(72) Inventor: Xiaoning Xi, Beijing (CN)

(21) Appl. No.: 16/452,120

(22) Filed: Jun. 25, 2019

(30) Foreign Application Priority Data
Jul. 4, 2018 (CN) 201810726724.2

(51) Int. Cl. G10L 13/02; G06F 3/16; G06K 9/62; G06K 9/03; G06T 7/70

(52) U.S. Cl. CPC G10L 13/02; G06F 3/16; G06K 9/6261; G06F 3/04842; G06T 7/70; G06K 2209/01; G06K 9/03

(57) ABSTRACT

A method and an apparatus for outputting voice are provided. The method includes acquiring an image for indicating a current reading state of a user, the current reading state including reading content and current operational information of the user; determining, in response to the reading content including a text, a current reading word of the reading content based on the current operational information of the user; and outputting voice corresponding to a portion of the text starting from the current reading word in the reading content. In this way, the current reading word may be determined according to an operation of the user, and then, the voice may be flexibly outputted.

### CROSS-REFERENCE TO RELATED APPLICATIONS

This application claims priority to Chinese Patent Application No. 201810726724.2, filed on Jul. 4, 2018, titled “Method and Apparatus for Outputting Voice,” which is hereby incorporated by reference in its entirety.

### TECHNICAL FIELD

Embodiments of the present disclosure relate to the field of computer technology, specifically to the field of Internet technology, and specifically to a method and apparatus for outputting voice.

### BACKGROUND

Reading is a very common activity in daily life. Due to a vision, a word recognition ability and the like, the elderly and the children often have different degrees of reading difficulties and cannot read on their own. In the existing technology, an electronic device may recognize text and play the voice corresponding to the text, thereby implementing the function of reading assistance.

### SUMMARY

Embodiments of the present disclosure propose a method and apparatus for outputting voice.

In a first aspect, the embodiments of the present disclosure provide a method for outputting voice. The method includes: acquiring an image for indicating a current reading state of a user, the current reading state including reading content and current operational information of the user; determining, in response to the reading content including a text, a current reading word of the reading content based on the current operational information of the user; and outputting voice corresponding to a portion of the text starting from the current reading word in the reading content.

In some embodiments, the current operational information includes an occlusion position of the user in the image. The determining, in response to the reading content including a text, a current reading word of the reading content based on the current operational information of the user includes: acquiring a text recognition result of the text in the image; dividing a region of the text in the image into a plurality of sub-regions; determining a sub-region of the occlusion position from the plurality of sub-regions; and using a starting word in the determined sub-region as the current reading word.

In some embodiments, the dividing a region of the text in the image into a plurality of sub-regions includes: determining text lines in the image, an interval between two adjacent text lines being greater than a preset interval threshold; and dividing, according to an interval between words in each text line, the text lines to obtain the plurality of sub-regions.

In some embodiments, the using a starting word in the determined sub-region as the current reading word further includes: using, in response to a text recognition result of the determined sub-region being successfully acquired, the starting word in the determined sub-region as the current reading word; and determining, in response to the text recognition result of the determined sub-region being not acquired, a sub-region adjacent to the determined sub-region in a last text line prior to a text line of the determined sub-region, and using a starting word in the adjacent sub-region as the current reading word.

In some embodiments, the acquiring an image for indicating a current reading state of a user includes: acquiring an initial image; determining, in response to the initial image having an occluded region, current operational information of the initial image; acquiring user selected region information of the initial image, and determining reading content in the initial image based on the user selected region information; and determining the determined current operational information and the determined reading content as the current reading state of the user.

In some embodiments, the acquiring an image for indicating a current reading state of a user further includes: sending, in response to determining the initial image not having the occluded region, an image collection command to an image collection device, to cause the image collection device to adjust a field of view and reacquire an image, and using the reacquired image as the initial image; and determining an occluded region in the reacquired initial image as the occluded region, and determining current operational information of the reacquired initial image.

In some embodiments, before the outputting voice corresponding to a portion of the text starting from the current reading word in the reading content, the method further includes: in response to determining an incomplete word located at an edge of the image, or determining a distance between an edge of the region of the word and the edge of the image being smaller than a designated interval threshold, sending a re-collection command to the image collection device, to cause the image collection device to adjust the field of view and re-collect an image.

In some embodiments, the outputting voice corresponding to a portion of the text starting from the current reading word in the reading content includes: converting, based on the text recognition result, the portion of the text from the current reading word to an end into voice audio; and playing the voice audio.

In a second aspect, the embodiments of the present disclosure provide an apparatus for outputting voice. The apparatus includes: an acquiring unit, configured to acquire an image for indicating a current reading state of a user, the current reading state including reading content and current operational information of the user; a determining unit, configured to determine, in response to the reading content including a text, a current reading word of the reading content based on the current operational information of the user; and an outputting unit, configured to output voice corresponding to a portion of the text starting from the current reading word in the reading content.

In some embodiments, the current operational information includes an occlusion position of the user in the image. The determining unit includes: an information acquiring module, configured to acquire a text recognition result of the text in the image; a dividing module, configured to divide a region of the text in the image into a plurality of sub-regions; a determining module, configured to determine a sub-region of the occlusion position from the plurality of sub-regions; and a word determining module, configured to use a starting word in the determined sub-region as the current reading word.

In some embodiments, the dividing module is further configured to: determine text lines in the image, an interval between two adjacent text lines being greater than a preset interval threshold; and divide, according to intervals between words in the text lines, the text lines to obtain the plurality of sub-regions.

In some embodiments, the word determining module further includes: a first determining sub-module, configured to use, in response to a text recognition result of the determined sub-region being successfully acquired, the starting word in the determined sub-region as the current reading word; and a second determining sub-module, configured to determine, in response to the text recognition result of the determined sub-region being not acquired, a sub-region adjacent to the determined sub-region in a last text line prior to a text line of the determined sub-region, and use a starting word in the adjacent sub-region as the current reading word.

In some embodiments, the acquiring unit includes: an image acquiring module, configured to acquire an initial image; an annotating module, configured to determine, in response to the initial image having an occluded region, current operational information of the initial image; a region determining module, configured to acquire user selected region information of the initial image, and determine reading content in the initial image based on the user selected region information; and a state determining module, configured to determine the determined current operational information and the determined reading content as the current reading state of the user.

In some embodiments, the acquiring unit further includes: a sending module, configured to send, in response to determining the initial image not having the occluded region, an image collection command to an image collection device to cause the image collection device to adjust a field of view and reacquire an image, and use the reacquired image as the initial image; and a reacquiring module, configured to determine an occluded region in the reacquired initial image as the occluded region, and determine current operational information of the reacquired initial image.

In some embodiments, the apparatus further includes: a re-collecting module, configured to, in response to determining an incomplete word located at an edge of the image, or determining a distance between an edge of the region of the word and the edge of the image being smaller than a designated interval threshold, send a re-collection command to the image collection device, to cause the image collection device to adjust the field of view and re-collect an image.

In some embodiments, the outputting unit includes: a converting module, configured to convert, based on the text recognition result, a portion of the text from the current reading word to an end into voice audio; and a playing module, configured to play the voice audio.

In a third aspect, the embodiments of the present disclosure provide an electronic device. The electronic device includes: one or more processors; and a storage device, configured to store one or more programs. The one or more programs, when executed by the one or more processors, cause the one or more processors to implement the method in any embodiment of the method for outputting voice.

In a fourth aspect, the embodiments of the present disclosure provide a computer readable storage medium storing a computer program. The program, when executed by a processor, implements the method in any embodiment of the method for outputting voice.

According to the voice outputting scheme provided by the embodiments of the present disclosure, the image for indicating the current reading state of the user is first acquired, and the current reading state includes reading content and current operational information of the user. Then, in response to the reading content including the text, the current reading word of the reading content is determined based on the current operational information of the user. Finally, the voice corresponding to a portion of the text starting from the current reading word in the reading content is outputted. According to the scheme of the method provided by the embodiments of the present disclosure, the intent of the user can be determined based on the current operational information of the user, thereby outputting the corresponding voice most relevant to the current reading word of the user in the image. In this way, in the embodiments of the present disclosure, the voice corresponding to all the words in the image is not rigidly outputted, but the current reading word may be determined according to an operation of the user, and thus, it is implemented that the voice is flexibly outputted.

### BRIEF DESCRIPTION OF THE DRAWINGS

After reading detailed descriptions of non-limiting embodiments given with reference to the following accompanying drawings, other features, objectives and advantages of the present disclosure will be more apparent:

FIG. 1 is a diagram of an exemplary system architecture in which the present disclosure is applicable;

FIG. 2 is a flowchart of an embodiment, of a method for outputting voice according to the present disclosure;

FIG. 3 is a schematic diagram of an application scenario of the method for outputting voice according to the present disclosure;

FIG. 4 is a flowchart of another embodiment of the method for outputting voice according to the present disclosure;

FIG. 5 is a schematic structural diagram of an apparatus for outputting voice according to the present disclosure; and

FIG. 6 is a schematic structural diagram of a computer system adapted to implement an electronic device according to the embodiments of the present disclosure.

### DETAILED DESCRIPTION OF EMBODIMENTS

The present disclosure will be described below in detail with reference to the accompanying drawings and in combination with the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

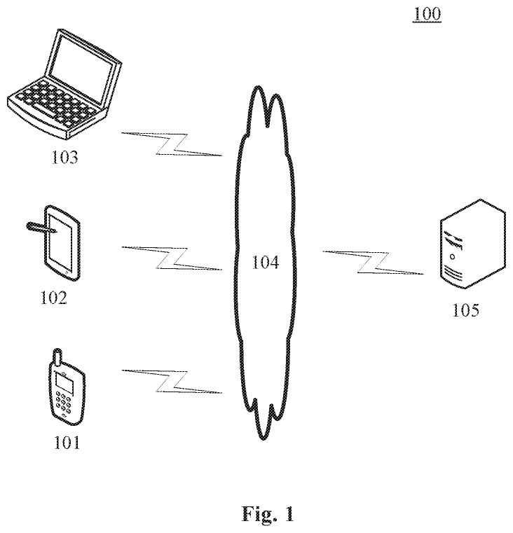

FIG. 1 shows an exemplary system architecture 100 in which a method for outputting voice or an apparatus for outputting voice according to the present disclosure may be applied.

As shown in FIG. 1, the system architecture 100 may include terminal devices 101, 102 and 103, a network 104, and a server 105. The network 104 serves as a medium providing a communication link between the terminal devices 101, 102 and 103 and the server 105. The network 104 may include various types of connections, for example, wired or wireless communication links, or optical fiber cables.

A user may interact with the server 105 via the network 104 using the terminal devices 101, 102 and 103, to receive or send messages. Cameras or various communication client applications (e.g., image recognition applications, shopping applications, search applications, instant communication tools, mailbox clients and social platform software) may be installed on the terminal devices 101, 102 and 103.

The terminal devices 101, 102 and 103 here may be hardware or software. When being the hardware, the terminal devices 101, 102 and 103 may be various electronic devices having a display screen, which include, but not limited to, a smart phone, a tablet computer, an e-book reader, a laptop portable computer, a desktop computer, etc. When being the software, the terminal devices 101, 102 and 103 may be installed in the above listed electronic devices. The terminal devices may be implemented as a plurality of pieces of software or a plurality of software modules (e.g., software or software modules for providing a distributed database service), or as a single piece of software or a single software module, which will not be specifically defined here.

The server 105 may be a server providing various services, for example, a backend server providing a support for the terminal devices 101, 102 and 103. The backend server may process (e.g., analyze) received data, and feed back the processing result (e.g., text information in an image) to the terminal devices.

It should be noted that the method for outputting voice provided by the embodiments of the present disclosure may be performed by the server 105 or the terminal devices 101, 102 and 103. Correspondingly, the apparatus for outputting voice may be provided in the server 105 or the terminal devices 101, 102 and 103.

It should be appreciated that the numbers of the terminal devices, the networks, and the servers in FIG. 1 are merely illustrative. Any number of terminal devices, networks, and servers may be provided based on actual requirements.

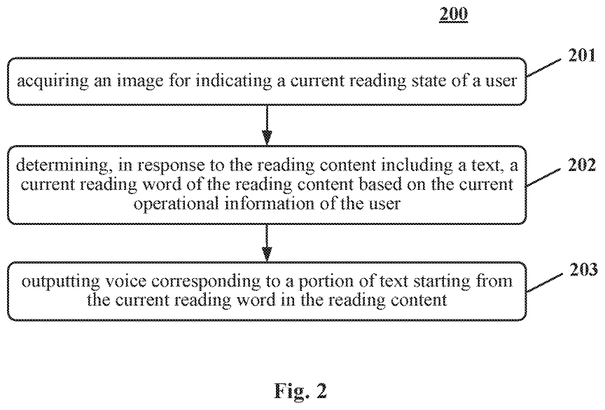

Further referring to FIG. 2, FIG. 2 illustrates a flow 200 of an embodiment of a method for outputting voice according to the present disclosure. The method for outputting voice includes the following steps 201 to 203.

Step 201 includes acquiring an image for indicating a current reading state of a user, the current reading state including reading content and current operational information of the user.

In this embodiment, an executing body (e.g., the server shown in FIG. 1) of the method for outputting voice may acquire the image, and the image may be used to indicate the current reading state of the user. The reading content is the content read by the user, and the content may include words, characters other than the words and/or graphics. The current operational information refers to information reflecting an operation performed by the user during the reading process. For example, the user may point to a certain word in the reading content using a finger, or point to a punctuation mark using a pen, and the like.

In some alternative implementations in this embodiment, step 201 may include:

acquiring an initial image;

determining, in response to the image having an occluded region, current operational information of the initial image;

acquiring user selected region information of the initial image, and determining reading content in the initial image based on the user selected region information; and

determining the determined current operational information and the determined reading content as the current reading state of the user.

In these implementations, the executing body acquires the initial image and may determine the occluded region. The occluded region here may refer to a region occluded by an object such as the finger or the pen over the image. For example, binarization may be performed on the initial image, a region (e.g., the area of the region is greater than a preset area and/or the shape of the region matches a preset shape) of a single numerical value in the binarized image may be determined, and this region may be used as the occluded region. The occlusion position of the occluded region may be annotated with a coordinate value representing the region. For example, the coordinate value may be a plurality of coordinate values representing a boundary of the occluded region. Alternatively, the occluded region is determined first, and then the coordinates of two opposite angles of a minimum enclosing rectangle of the occluded region is used as the coordinate value representing the occluded region. Thereafter, the coordinate value indicating the occluded region may be used as the current operational information.

The executing body may present the initial image to the user, or send the initial image to the terminal such that the initial image is presented to the user by the terminal. In this way, the user may select, in the initial image, a partial image as the region of the reading content. Then, the executing body can determine the region of the reading content.

In the above implementation, the occluded region operated by the user and the region of the reading content in the image may be annotated in advance. In this way, the current operational information can be accurately determined, and thus, the current reading word in the reading content is more accurately determined.

In some alternative implementations in this embodiment, based on the above implementation, step 201 may include:

sending, in response to determining that the initial image does not have the occluded region, an image collection command to an image collection device, to cause the image collection device to adjust a field of view and reacquire an image, and using the reacquired image as the initial image; and

determining an occluded region in the reacquired initial image as the occluded region, and annotating the current operational information for the reacquired initial image.

In these implementations, in response to determining that the initial image does riot have the occluded region, the executing body may send the command to the image collection device, to cause the image collection device to adjust the field of view and reacquire the image according to the adjusted field of view. The image collection device may be a camera or an electronic device with a camera. The adjustment of the field of view here may be to expand the field of view, or to rotate the camera to change the shooting direction.

The executing body in the above implementations may autonomously send the image collection command according to the occluded region of the user. Thus, it as ensured that the adjustment is performed in time to reacquire the image in the case where the initial image does not have the occluded region.

Step 202 includes determining, in response to the reading content including a text, a current reading word of the reading content based on the current operational information of the user.

In this embodiment, in the case where the reading content in the image includes the text, the executing body responds that the current reading word of the reading content is determined based on the current operational information of the user. The current reading word is the word currently read by the user.

In practice, the current reading word of the reading content may be determined in various ways. For example, if the current operational information refers to the position pointed to by the finger of the user in the image, the word at the position may be determined as the current reading word. In addition, the current operational information may alternatively be the position occluded by the finger of the user in the image. As such, the executing body may determine the word closest to the position occluded by the finger as the current reading word.

In some alternative implementations in this embodiment, after step 201, the method may further include:

in response to determining an incomplete word located at an edge of the image, or determining a distance between an edge of the region of the text and the edge of the image being smaller than a designated interval threshold, sending a re-collection command to the image collection device, to cause the image collection device to adjust the field of view and re-collect an image.

In these implementations, the executing body may reacquire the image if the executing body determines that the reading content in the image is incomplete. In practice, the image may only have the left half of the reading content. That is, the image includes an incomplete word. For example, only the left half “go” of “good” is displayed at the edge of the image. Alternatively, the word is located at the edge of the image, and the distance of the word from the edge of the image is smarter than the designated interval threshold. In the above case, it may be considered that the acquired image does not contain all of the content currently read by the user. In this case, the image may be reacquired to acquire the complete reading content.

The executing body in the above implementations may autonomously determine whether the reading content is complete, and then acquire the complete reading content in time. At the same time, according to the above implementations, the inconsistency between the content read by the user and the outputted content caused by the incomplete reading content in the image is avoided, thus improving the accuracy of the voice output.

Step 203 includes outputting voice corresponding to the a portion of text starting from the current reading word in the reading content.

In this embodiment, the executing body may output the voice corresponding to the portion of text starting from the current reading word in the reading content. In this way, for the text in the image, text recognition may be performed at the position where the user is reading according to the operation of the user, and the recognized portion of the text may be converted into the voice for output.

In practice, the executing body may output the voice in various ways. For example, the executing body may use the current reading word as the starting word of the output, and generate and continuously output the voice corresponding to the text from the current reading word to the end of the text. The executing body may alternatively start with the current reading word, and generate and segmentally output the voice corresponding to the text from the current reading word to the end of the text.

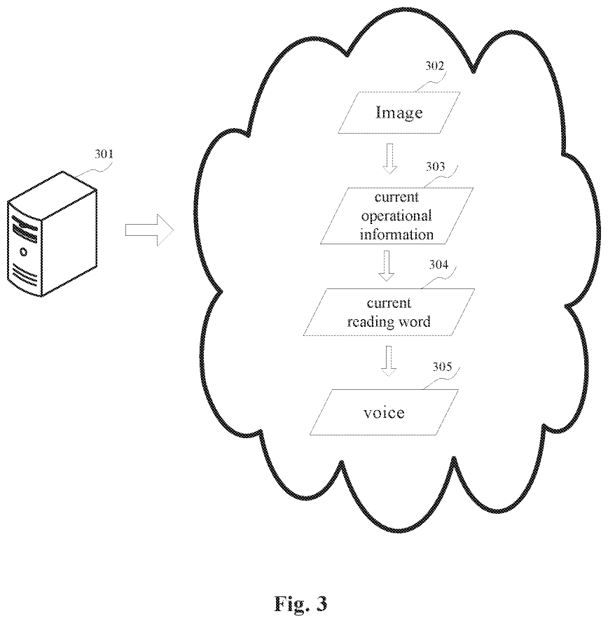

Further referring to FIG. 3, FIG. 3 is a schematic diagram of an application scenario of the method for outputting voice according to this embodiment. In the application scenario of FIG. 3, the executing body 301 acquires the image 302 for indicating the current reading state of the user. Here, the current reading state includes the reading content and the current operational information “pointing to a word with a finger” 303 of the user. In response to the reading content including the text, the current reading word 304 of the reading content is determined based on the current operational information 303 of the user. The voice 305 corresponding to the portion of the text starting from the current reading word 304 in the reading content is outputted.

According to the method provided by the above embodiment of the present disclosure, the voice corresponding to the text in the reading content can be outputted based on the current operational information of the user. In this way, in the embodiment of the present disclosure, the voice corresponding to all the words in the image is not rigidly outputted, but the current reading word may be determined according to the operation of the user, and then, the voice may be flexibly outputted. Moreover, in the embodiment, it is not necessary to convert all the words in the reading into voice, but a part of the words may be converted, thereby improving the output efficiency of the voice.

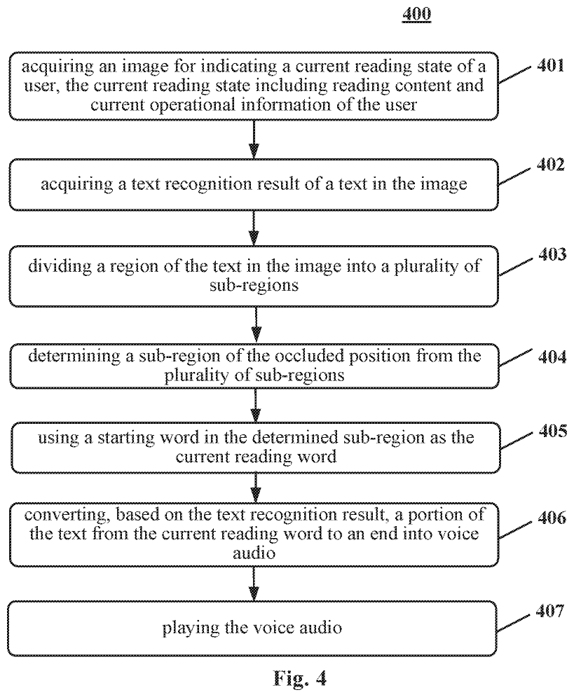

Further referring to FIG. 4, FIG. 4 illustrates a flow 400 of another embodiment of the method for outputting voice. The flow 400 of the method for outputting voice includes the following steps 401 to 407.

Step 401 includes acquiring an image for indicating a current reading state of a user, the current reading state including reading content and current operational information of the user.

In this embodiment, an executing body (e.g., the server shown in FIG. 1) of the method for outputting voice may acquire the image, and the image may be used to indicate the current reading state of the user. The reading content is the content read by the user, and the content may include words, characters other than the words and/or graphics. The current operational information refers to information reflecting an operation performed by the user during the reading process. For example, the user may point to a certain word in the reading content using a finger, or point to a punctuation mark using a pen, and the like.

Step 402 includes acquiring a text recognition result of a text in the image.

In this embodiment, the executing body may acquire the text recognition result locally or from other electronic devices such as a server. If the text recognition result is obtained, it may be determined that the reading content of the image includes the text. The text recognition result is the result obtained by recognizing the text in the image. The text recognized here may be all of the text in the reading content, or may be a portion of the text, for example, may be the portion of the text from the current reading word to the end. Specifically, the text recognition process may be performed by the executing body, or may be performed by a server after the executing body sends the reading content to the server.

Step 403 includes dividing a region of the text in the image into a plurality of sub-regions.

In this embodiment, the current operational information includes an occlusion position of the user in the image. In response to the reading content of the image including the text, the executing body may divide the region of the text in the image into the plurality of sub-regions.

In practice, the executing body may divide the sub-regions in various ways. For example, the executing body may divide the region of the text into sub-regions of equal size, according to a preset number of sub-regions.

In some alternative implementations in this embodiment, step 403 includes:

determining text lines in the image, an interval between two adjacent text lines being greater than a preset interval threshold; and

dividing, according to an interval between words in each text line, the text lines to obtain the plurality of sub-regions.

In these implementations, if intervals between respective words of two adjacent groups in the image are consistent, which are greater than the preset interval threshold, and the number of words in each group is greater than a certain numerical value, the two groups of words are adjacent text lines. If the interval between the words in a text line is greater than a certain numerical value, the interval may be used as a boundary between two sub-regions. The interval between two sentences separated by a comma, a period, a semicolon, etc. in the text line, the interval between two paragraphs and the like may be used as the boundary between adjacent sub-regions. In the process of dividing the sub-regions, the executing body may draw an interval line segment in a certain interval, to distinguish and mark the positions of the sub-regions. The interval line segment drawn in the text line may be perpendicular to an interval line segment above or below the text line.

Step 404 includes determining a sub-region of the occluded position from the plurality of sub-regions.

In this embodiment, the executing body may determine the sub-region of the occluded position from the plurality of divided sub-regions. Specifically, the executing body may perform binarization on the image, and determine a region of a single numerical value in the binarized image, and use the region as the occluded region. The sub-region of the occluded region may be one or more. If there are a plurality of sub-regions, one sub-region may be randomly selected from the plurality of sub-regions, or the sub-region whose position is at the top may be selected.

Step 405 includes using a starting word in the determined sub-region as the current reading word.

In this embodiment, the executing body may use the word at the starting position in the determined sub-region as the current reading word. Specifically, the starting word may be determined in a word reading order. For example, if the text is laterally typeset, the leftmost word of the sub-region may be used as the starting word. If the text is vertically typeset, the topmost word of the sub-region may be used as the starting word.

In some alternative implementations in this embodiment, step 405 may include:

using, in response to a text recognition result of the determined sub-region being successfully acquired, the starting word in the determined sub-region as the current reading word; and

determining, in response to the text recognition result of the determined sub-region being not acquired, a sub-region adjacent to the determined sub-region in a last text line prior to a text line of the determined sub-region, and using a starting word in the adjacent sub-region as the current reading word.

In these implementations, the executing body may acquire the text recognition result from the determined sub-region during the process of acquiring the text recognition result of the text in the image. If the acquisition is successful, it means that the determined sub-region contains a recognizable text. If the text recognition result of the determined sub-region is not acquired within a preset time period, it means that the determined sub-region may not contain the recognizable text. The text corresponding to the operation of the user may be in the last previous text line. The executing body may then determine the current reading word in the adjacent sub-region.

Step 406 includes converting, based on the text recognition result, a portion of the text from the current reading word to an end into voice audio.

In this embodiment, after acquiring the text recognition result, the executing body may convert the portion of the text from the current reading word to the end from the text format into an audio format by using the text recognition result.

Step 407 includes playing the voice audio.

In this embodiment, the executing body may play the voice audio from the current reading word to the ending word. In this way, different voice audios may be played based on the operation of the user on the text in the image.

In this embodiment, the current reading word of the user is accurately determined by dividing the sub-regions. At the same time, the text lines are determined and divided through the intervals, and thus, the stability and accuracy of the division of the sub-regions can increase. In addition, in this embodiment, the voice audio played based on the same reading content may be different according to the operation of the user, thereby more accurately satisfying the needs of the user.

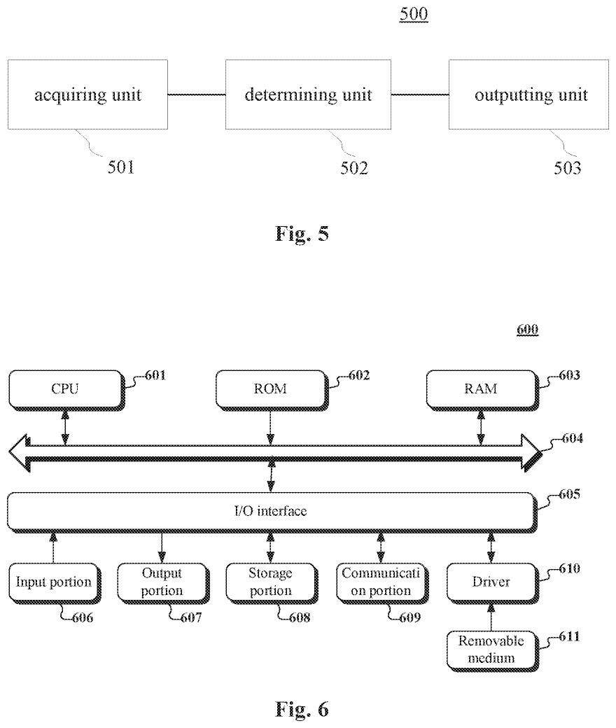

Further referring to FIG. 5, as an implementation of the method shown in the above drawings, the present disclosure provides an embodiment of an apparatus for outputting voice. The embodiment, of the apparatus corresponds to the embodiment of the method shown in FIG. 2, and the apparatus may be applied in various electronic devices.

As shown in FIG. 5, the apparatus 500 for outputting voice in this embodiment includes: an acquiring unit 501, a determining unit 502 and an outputting unit 503. The acquiring unit 501 is configured to acquire an image for indicating a current reading state of a user, the current reading state including reading content and current operational information of the user. The determining unit 502 is configured to determine, in response to the reading content including a text, a current reading word of the reading content based on the current operational information of the user. The outputting unit 503 is configured to output voice corresponding to a portion of the text starting from the current reading word in the reading content.

In some embodiments, the acquiring unit 501 of the apparatus 500 for outputting voice may acquire the image, and the image may be used to indicate the current reading state of the user. The reading content is the content read by the user, and the content may include words, characters other than the words and/or graphics. The current operational information refers to information reflecting an operation performed by the user during the reading process. For example, the user may point to a certain word in the reading content using a finger, or point to a punctuation mark using a pen, and the like.

In some embodiments, in the case where the reading content in the image includes the text, the determining unit 502 responds that the current reading word of the reading content is determined based on the current operational information of the user. The current reading word is the word currently read by the user.

In some embodiments, the outputting unit 503 may output the voice corresponding to the portion of the text starting from the current reading word in the reading content. In this way, according to the operation of the user, the text in the image may be converted into the voice to be outputted.

In some alternative implementations in this embodiment, the current operational information includes an occlusion position of the user in the image. The determining unit includes: an information acquiring module, configured to acquire a text recognition result of a text in the image; a dividing module, configured to divide a region of the text in the image into a plurality of sub-regions; a determining module, configured to determine a sub-region of the occlusion position from the plurality of sub-regions; and a word determining module, configured to use a starting word in the determined sub-region as the current reading word.

In some alternative implementations in this embodiment, the dividing module is further configured to: determine text lines in the image, an interval between two adjacent text lines being greater than a preset interval threshold; and divide, according to an interval between words in each text line, the text lines to obtain the plurality of sub-regions.

In some alternative implementations in this embodiment, the word determining module includes an acquiring sub-module, configured to acquire the text recognition result of the text in the image.

In some alternative implementations in this embodiment, the word determining module further includes: a first determining sub-module, configured to use, in response to a text recognition result of the determined sub-region being successfully acquired, the starting word in the determined sub-region as the current reading word; and a second determining sub-module, configured to determine, in response to the text recognition result of the determined sub-region being not acquired, a sub-region adjacent to the determined sub-region in a last text line prior to a text line of the determined sub-region, and use a starting word in the adjacent sub-region as the current reading word.

In some alternative implementations in this embodiment, the acquiring unit includes: an image acquiring module, configured to acquire an initial image; an annotating module, configured to determine, in response to the initial image having an occluded region, current operational information of the initial image; a region determining module, configured to acquire user selected region information of the initial image, and determine reading content in the initial image based on the user selected region information; and a state determining module, configured to determine the determined current operational information and the determined reading content as the current reading state of the user.

In some alternative implementations in this embodiment, the acquiring unit further includes: a sending module, configured to send, in response to determining the initial image not having the occluded region, an image collection command to an image collection device to cause the image collection device to adjust a field of view and reacquire an image, and use the reacquired image as the initial and a reacquiring module, configured to determine an occluded region in the reacquired initial image as the occluded region, and determine current operational information of the reacquired initial image.

In some alternative implementations in this embodiment, the apparatus further includes: a re-collecting module, configured to, in response to determining an incomplete word located at an edge of the image, or determining a distance between an edge of the region of the word and the edge of the image being smaller than a designated interval threshold, send a re-collection command to the image collection device, to cause the image collection device to adjust the field of view and re-collect an image.

In some alternative implementations in this embodiment, the outputting unit includes: a converting module, configured to convert, based on the text recognition result, the text from the current reading word to an end into voice audio; and a playing module, configured to play the voice audio.

Referring to FIG. 6, FIG. 6 is a schematic structural diagram of a computer system 600 adapted to implement an electronic device of the embodiments of the present disclosure. The electronic device shown in FIG. 6 is merely an example, and should not bring any limitations to the functions and the scope of use of the embodiments of the present disclosure.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse, etc.; an output portion 607 including a cathode ray tube (CRT), a liquid crystal display device (LCD), a speaker etc.; a storage portion 608 including a hard disk and the like; and a communication portion 609 including a network interface card such as a LAN (local region network) card and a modem. The communication portion 609 performs communication processes via a network such as the Internet. A driver 610 is also connected to the I/O interface 605 as required. A removable medium 611 such as a magnetic disk, an optical disk, a magneto-optical disk, and a semiconductor memory may be installed on the driver 610, to facilitate the retrieval of a computer program from the removable medium 611, and the installation thereof on the storage portion 608 as needed.

In particular, according to embodiments of the present disclosure, the process described above with reference to the flow chart may be implemented as a computer software program. For example, an embodiment of the present disclosure includes a computer program product, including a computer program hosted on a computer readable medium, the computer program including program codes for performing the method as illustrated in the flowchart. In such an embodiment, the computer program may be downloaded and installed from a network via the communication portion 609, and/or may be installed from the removable medium 611. The computer program, when executed by the central processing unit (CFU) 601, implements the above mentioned functionalities defined in the method of the present disclosure. It should be noted that the computer readable medium in the present disclosure may be a computer readable signal medium, a computer readable storage medium, or any combination of the two. For example, the computer readable storage medium may be, but not limited to: an electronic, magnetic, optical, electromagnetic, infrared, or semiconductor system, apparatus, or element, or any combination of the above. A more specific example of the computer readable storage medium may include, but not limited to: an electrical connection having one or more wires, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs, which may be used by a command execution system, apparatus or element or incorporated thereto. In the present disclosure, the computer readable signal medium may include a data signal that is propagated in a baseband or as a part of a carrier wave, which carries computer readable program codes. Such propagated data signal may be in various forms, including, but not limited to, an electromagnetic signal, an optical signal, or any suitable combination of the above. The computer readable signal medium may also be any computer readable medium other than the computer readable storage medium. The computer readable medium is capable of transmitting, propagating or transferring programs for use by, or used in combination with, a command execution system, apparatus or element. The program codes contained on the computer readable medium may be transmitted with any suitable medium including, but not limited to, wireless, wired, optical cable, RF medium, or any suitable combination of the above.

The flowcharts and block diagrams in the accompanying drawings illustrate architectures, functions and operations that may be implemented according to the system, the method, and the computer program product of the various embodiments of the present disclosure. In this regard, each of the blocks in the flowcharts or block diagrams may represent a module, a program segment, or a code portion, the module, the program segment, or the code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed substantially in parallel, or they may sometimes be executed in a reverse sequence, depending on the function involved. It should also be noted that each block in the block diagrams and/or flowcharts as well as a combination of blocks may be implemented using a dedicated hardware-based system executing specified functions or operations, or by a combination of dedicated hardware and computer instructions.

The units involved in the embodiments of the present disclosure may be implemented by means of software or hardware. The described units may also be provided in a processor. For example, the processor may be described as: a processor comprising an acquiring unit, a determining unit and an outputting unit. The names of these units do not in some cases constitute a limitation to such units themselves. For example, the acquiring unit may alternatively be described as “a unit for acquiring an image for indicating a current reading state of a user.”

In another aspect, the present disclosure further provides a computer readable medium. The computer readable medium may be the computer readable medium included in the apparatus described. In the above embodiments, or a stand-alone computer readable medium not assembled into the apparatus. The computer readable medium carries one or more programs. The one or more programs, when executed by the apparatus, cause the apparatus to: acquire an image for indicating a current reading state of a user, the current reading state including reading content and current operational information of the user; determine, in response to the reading content including a text, a current reading word of the reading content based on the current operational information of the user; and output voice corresponding to a portion of the text starting from the current reading word in the reading content.

The above description is only an explanation for the preferred embodiments of the present disclosure and the applied technical principles. It should be appreciated by those skilled in the art that the inventive scope of the present disclosure is not limited to the technical solution formed by the particular combinations of the above technical features. The inventive scope should also cover other technical solutions formed by any combinations of the above technical features or equivalent features thereof without departing from the concept of the invention, for example, technical solutions formed by replacing the features as disclosed in the present disclosure with (but not limited to) technical features with similar functions.

What is claimed is:

1. A method for outputting voice, comprising:
acquiring an image for indicating a current reading state of a user, the current reading state including reading content and current operational information of the user;
determining, in response to the reading content including a text, a current reading word of the reading content based on the current operational information of the user; and
outputting voice corresponding to a portion of the text starting from the current reading word in the reading content.

2. The method according to claim 1, wherein the current operational information includes an occlusion position of the user in the image, and
the determining, in response to the reading content including a text, a current reading word of the reading content based on the current operational information of the user comprises:
acquiring a text recognition result of the text in the image;
dividing a region of the text in the image into a plurality of sub-regions;
determining a sub-region of the occlusion position from the plurality of sub-regions; and
using a starting word in the determined sub-region as the current reading word.

3. The method according to claim 2, wherein the dividing a region of the text in the image into a plurality of sub-regions comprises:
determining text lines in the image, an interval between two adjacent text lines being greater than a preset interval threshold; and
dividing, according to an interval between words in each text line, the text lines to obtain the plurality of sub-regions.

4. The method according to claim 2, wherein the using a starting word in the determined sub-region as the current reading word further comprises:
using, in response to a text recognition result of the determined sub-region being successfully acquired, the starting word in the determined sub-region as the current reading word; and
determining, in response to the text recognition result of the determined sub-region being not acquired, a sub-region adjacent to the determined sub-region in a last text line prior to a text line of the determined sub-region, and using a starting word in the adjacent sub-region as the current reading word.

5. The method according to claim 1, wherein the acquiring an image for indicating a current reading state of a user comprises:
acquiring an initial image;
determining, in response to the initial image having an occluded region, current operational information of the initial image;
acquiring user selected region information of the initial image, and determining reading content in the initial image based on the user selected region information; and
determining the determined current operational information and the determined reading content as the current reading state of the user.

6. The method according to claim 5, wherein the acquiring an image for indicating a current reading state of a user further comprises:
sending, in response to determining the initial image not having the occluded region, an image collection command to an image collection device, to cause the image collection device to adjust a field of view and reacquire an image, and using the reacquired image as the initial image; and
determining an occluded region in the reacquired initial image as the occluded region, and determining current operational information of the reacquired initial image.

7. The method according to claim 1, wherein before the outputting voice corresponding to a portion of the text starting from the current reading word in the reading content, the method further comprises:
in response to determining an incomplete word located at an edge of the image, or determining a distance between an edge of the region of the word and the edge of the image being smaller than a designated interval threshold, sending a re-collection command to the image collection device, to cause the image collection device to adjust the field of view and re-collect an image.

8. The method according to claim 2, wherein the outputting voice corresponding to a portion of the text starting from the current reading word in the reading content comprises:
converting, based on the text recognition result,
the text from the current reading word to an end into voice audio; and
playing the voice audio.

9. An apparatus for outputting voice, comprising:
at least one processor; and
a memory storing instructions, wherein the instructions when executed by the at least one processor, cause the at least one processor to perform operations, the operations comprising:
acquiring an image for indicating a current reading state of a user, the current reading state including reading content and current operational information of the user;
determining, in response to the reading content including a text, a current reading word of the reading content based on the current operational information of the user; and
outputting a portion of voice corresponding to the text starting from the current reading word in the reading content.

10. The apparatus according to claim 9, wherein the current operational information includes an occlusion position of the user in the image, and
the determining, in response to the reading content including a text, a current reading word of the reading content based on the current operational information of the user comprises:
acquiring a text recognition result of the text in the image;
dividing a region of the text in the image into a plurality of sub-regions;
determining a sub-region of the occlusion position from the plurality of sub-regions; and
using a starting word in the determined sub-region as the current reading word.

11. The apparatus according to claim 10, wherein the dividing a region of the text in the image into a plurality of sub-regions comprises:
determining text lines in the image, an interval between two adjacent text lines being greater than a preset interval threshold; and
dividing, according to an interval between words in each text line, the text lines to obtain the plurality of sub-regions.

12. The apparatus according to claim 10, wherein the using a starting word in the determined sub-region as the current reading word further comprises:
using, in response to a text recognition result of the determined sub-region being successfully acquired, the starting word in the determined sub-region as the current reading word; and
determining, in response to the text recognition result of the determined sub-region being not acquired, a sub-region adjacent to the determined sub-region in a last text line prior to a text line of the determined sub-region, and using a starting word in the adjacent sub-region as the current reading word.

13. The apparatus according to claim 9, wherein the acquiring an image for indicating a current reading state of a user comprises:
acquiring an image;
determining, in response to the initial image having an occluded region, current operational information of the initial image;
acquiring user selected region information of the initial image, and determining reading content in the initial image based on the user selected region information; and
determining the determined current operational information and the determined reading content as the current reading state of the user.

14. The apparatus according to claim 13, wherein the acquiring an image for indicating a current reading state of a user further comprises:
sending, in response to determining the initial image not having the occluded region, an image collection command to an image collection device to cause the image collection device to adjust a field of view and reacquire an image, and using the reacquired image as the initial image; and
determining an occluded region in the reacquired initial image as the occluded region, and determining current operational information of the reacquired initial image.

15. The apparatus according to claim 10, wherein before the outputting voice corresponding to a portion of the text starting from the current reading word in the reading content, the operations further comprise:
in response to determining an incomplete word located at an edge of the image, or determining a distance between an edge of the region of the word and the edge of the image being smaller than a designated interval threshold, sending a re-collection command to the image collection device, to cause the image collection device to adjust the field of view and re-collect an image.

16. The apparatus according to claim 10, wherein the outputting voice corresponding to a portion of the text starting from the current reading word in the reading content comprises:
converting, based on the text recognition result, the text from the current reading word to an end into voice audio; and
playing the voice audio.

17. A non-transitory computer readable storage medium, storing a computer program, wherein the program, when executed by a processor, causes the processor to perform operations, the operations comprising:
acquiring an image for indicating a current reading state of a user, the current reading state including reading content and current operational information of the user;
determining, in response to the reading content including a text, a current reading word of the reading content based on the current operational information of the user; and
outputting voice corresponding to a portion of the text starting from the current reading word in the reading content.
